(19) United States
(12) Patent Application Publication
(10) Pub. No.: US 2012/0230798 A1
(43) Pub. Date: Sep. 13, 2012

(54) LOCKING FASTENER

(75) Inventor: John Thomas Sterle, Clifton Park, NY (US)

(73) Assignee: General Electric Company

(21) Appl. No.: 13/044,955

(22) Filed: Mar. 10, 2011

(51) Int. Cl. F16B 39/00

(52) U.S. Cl. 411/120

(57) ABSTRACT

A locking fastener is provided having a main body with first and second axially directed surfaces, where both surfaces surround an axis, and a threaded surface and a slot. The slot extends from the first axially directed surface to the second axially directed surface. A first portion of the threaded surface is located above the slot and a second portion is located below the slot. A locking recess is formed in the main body, and extends substantially parallel to the axis and extends to or through the slot. The locking recess has an internal threaded surface portion, which is configured to engage an external threaded surface portion of a locking member. The locking member passes axially through the locking recess and slot, and a tightening of the locking member results in a relative axial movement between the first and second portions of the threaded surface that locks the locking fastener.

### BACKGROUND OF THE INVENTION

The present invention described herein relates generally to a locking fastener. More specifically, the present invention relates to a locking fastener having a locking element that changes the thread pitch.

Mechanical fasteners are used in many applications. However, a problem encountered with fasteners is that they tend to work loose due to vibrations or temperature variations. Many various solutions have attempted to solve this problem. In one attempt a locking type washer is used to provide friction between a nut or bolt and opposing surface. In another attempt, radial oriented screws have been used that pass through a fastener (e.g., a nut) and impinge against a bolt, and the friction between the bolt and set screw is used to help lock the fastener. However, all these known attempts have failed to satisfactorily produce a locking fastener that can simply and securely lock a fastener in a desired position.

### BRIEF DESCRIPTION OF THE INVENTION

In an aspect of the present invention, a locking fastener is provided. The locking fastener includes a main body having a first axially directed surface and a second axially directed surface, where both the first axially directed surface and the second axially directed surface surround an axis. The first axially directed surface face inward toward the axis and the second axially directed surface faces away from the axis. A top surface extends between the first axially directed surface and the second axially directed surface at a first end of the main body. A bottom surface extends between the first axially directed surface and the second axially directed surface at a second end of the main body. The main body includes at least one threaded surface having a plurality of substantially axially directed threads. The main body also includes at least one slot extending from the first axially directed surface to the second axially directed surface, and a first portion of the at least one threaded surface is located above the slot and a second portion of the at least one threaded surface is located below the slot. A locking recess is formed in the main body, and extends substantially parallel to the axis and extends to or through the at least one slot. The locking recess has an internal threaded surface portion. A locking member has an external threaded surface configured to engage the internal threaded surface portion of the locking recess. The locking member passes axially through the locking recess and the slot and a tightening of the locking member results in a relative axial movement between the first portion of the at least one threaded surface and the second portion of the at least one threaded surface, and this relative axial movement locks the locking fastener.

In another aspect of the present invention, a locking fastener is provided having a main body having a first axially directed surface and a second axially directed surface, where both the first and second axially directed surfaces surround an axis. At least one threaded surface is on the main body. At least one slot is in the main body, and this slot extends from the first axially directed surface to the second axially directed surface. A first portion of the at least one threaded surface is located above the slot and a second portion of the at least one threaded surface is located below the slot. At least one locking recess is formed in the main body, and extends substantially parallel to the axis and extends to or through the slot. The at least one locking recess has an internal threaded surface portion. At least one locking member has an external threaded surface, which is configured to engage the internal threaded surface portion of the locking recess. The locking member passes axially through the locking recess and the slot, and a tightening of the locking member results in a relative axial movement between the first portion and second portion of the at least one threaded surface, and this relative axial movement locks the locking fastener.

### BRIEF DESCRIPTION OF THE DRAWINGS

FIG. 1 is a perspective illustration of a locking fastener according to an aspect of the present invention.

FIG. 2 is a cross-sectional illustration of a locking fastener according to an aspect of the present invention.

FIG. 3 is a cross-sectional illustration of a locking fastener according to an aspect of the present invention.

FIG. 4 is a partial, cross-sectional illustration of a terminal assembly using a locking fastener according to an aspect of the present invention.

FIG. 5 is a cross-sectional illustration of a locking fastener according to an aspect of the present invention.

### DETAILED DESCRIPTION OF THE INVENTION

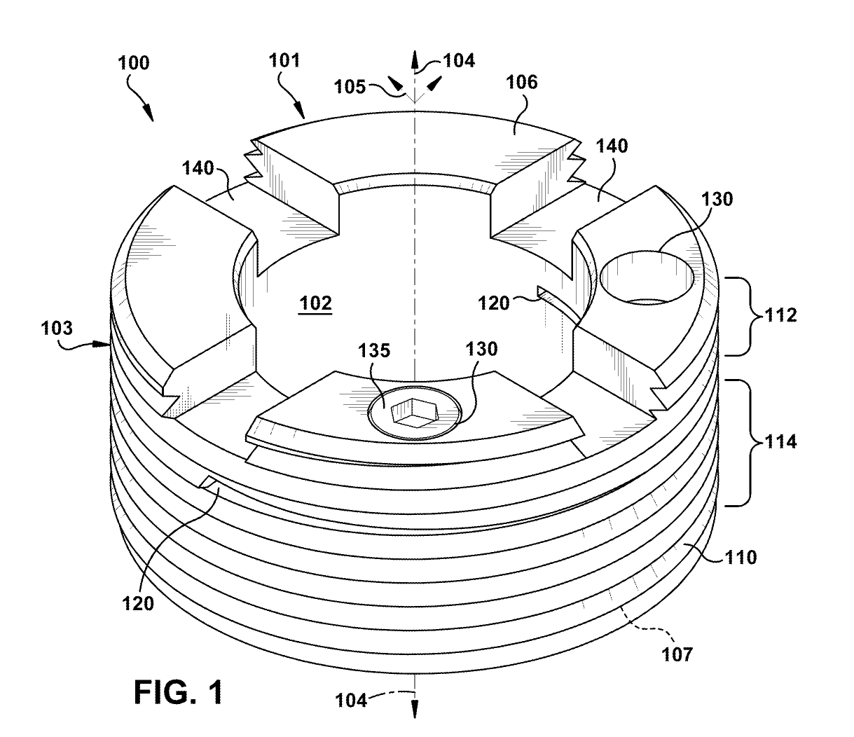

FIG. 1 illustrates a perspective view of a locking fastener according to an aspect of the present invention. The locking fastener 100 includes a main body 101 having a first axially directed surface 102 and a second axially directed surface 103. Both the first axially directed surface 102 and the second axially directed surface 103 surround an axis 104. A radial direction 105 is perpendicular to and extends 360 degrees around the axis 104. The first axially directed surface 102 faces inward toward the axis 104 and the second axially directed surface 103 faces away from the axis 104.

A top surface 106 extends between the first axially directed surface 102 and the second axially directed surface 103 at a first end of the main body 101. A bottom surface 107, which is generally opposed to the top surface 106, extends between the first axially directed surface 102 and the second axially directed surface 103 at a second end of the main body 101.

A threaded surface 110 is located on the main body 101, and the threaded surface 110 includes a plurality of substantially axially directed and radially projecting threads. The threads may be located on the inner surface 102, the outer surface 103 or both. The threads are generally circumferentially located on these surfaces and form a spiral pattern.

A slot 120 is formed in the main body 101 and extends from the first axially directed surface 102 to the second axially directed surface 103. A first portion 112 of the threaded surface is located above the slot 120 and a second portion 114 of the threaded surface is located below the slot 120. The slot 120 may be configured to extend about 180 degrees or about half way around the main body 101. However, it is to be understood that the slot could be configured to extend greater or less than 180 degrees as well. For example, the slot 120 could be configured to extend about 90 degrees around main body 101, or the slot could be configured to extend about 270 degrees around main body 101. In addition, multiple slots (not shown in FIG. 1) could be used and the multiple slots could be disposed to be substantially co-linear with each other, or they may be axially separated so that they are substantially parallel with each other.

A locking recess 130 is formed in the main body 101 and this locking recess extends substantially parallel to the axis 104 while extending through or to slot 120. The locking recess 130 may have an internal threaded surface portion and/or an internal smooth surface portion. A locking member 135, such as a bolt or screw, can be inserted into locking recess 130. The locking member 135 has an external threaded surface that is configured to engage the internal threaded surface portion of the locking recess 130. The locking member 135 could be a locking type fastener by means of a thread locking compound or the fastener 135 could be staked (e.g., displacement of material from one component into the mating component) in position after tightening. The locking member 135 could use a plastic locking element or thread locking compound on the outer threads to create a friction lock.

In use and to lock fastener 100, the locking member 135 passes axially through the locking recess 130 and slot 120. As locking member is tightened (or screwed into locking recess 130, a relative axial movement results between the first portion 112 of the threaded surface and the second portion 114 of the threaded surface, and this relative axial movement locks the locking fastener in the desired position. The recessed areas 140 on the top of the fastener are provided to assist in installing the fastener. A driving tool (not shown) having a complementary shape to the recessed areas 140 can be used to engage and drive the locking fastener 100 into the desired position.

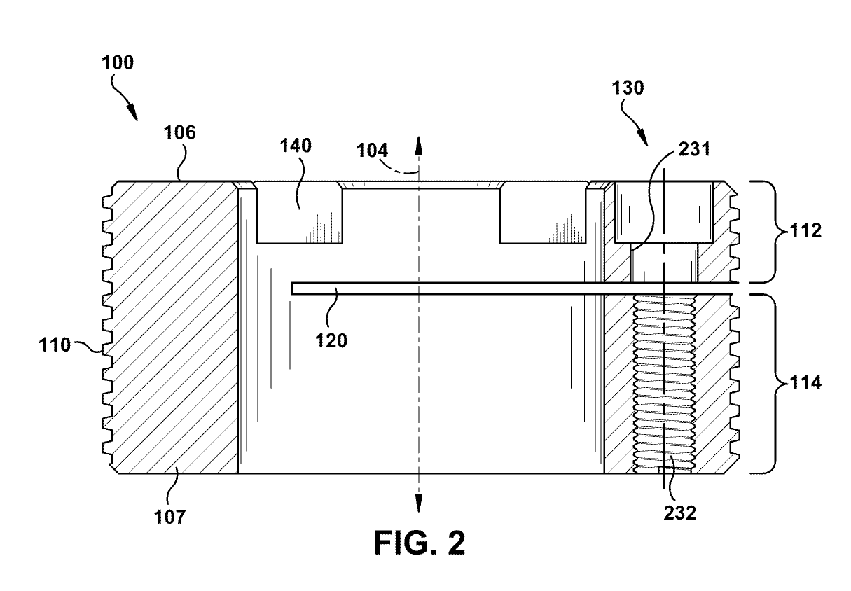

FIG. 2 illustrates a cross-sectional view of locking fastener 100. The locking recess 130 includes an upper portion 231 located above slot 120. This upper portion 231 is configured with smooth interior walls and is stepped to accommodate the head of the locking member 135. The lower portion 232 of locking recess 130 (i.e., the portion below slot 120) is configured with an interior threaded surface. As the locking member 135 is tightened, the head of the locking member makes contact with the stepped portion (or axial surface) of upper portion 231. As the locking member is further tightened, the upper portion 112 and lower portion 114 are pulled towards each other. As shown in FIG. 2, the slot 120 is positioned so that portion 112 will be forced down towards lower portion 114. The effect of this relative axial movement changes the thread pitch between the locking fastener 100 and the threaded sidewalls (not shown) into which the locking fastener 100 is inserted.

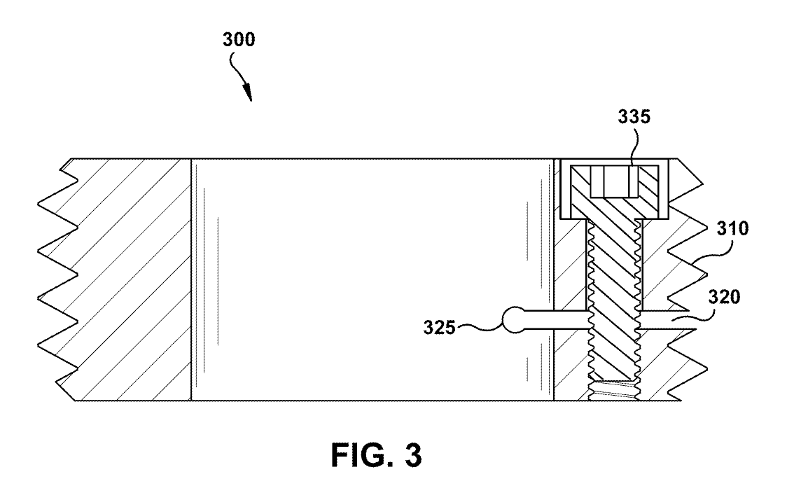

FIG. 3 illustrates a cross-sectional view of a locking fastener 300 where the slot 320 includes an enlarged stress relieving area 325 at both ends of the slot 320. The stress relieving area 325 is provided to distribute and relieve stress at the ends of slot 320 during a locking operation. For example, as locking fastener 335 is tightened the areas above and below slot 320 will be forced towards each other, thereby changing the pitch of threads 310 near slot 320. This change in thread pitch will lock the fastener 300 in the threaded hole (not shown) into which it is inserted.

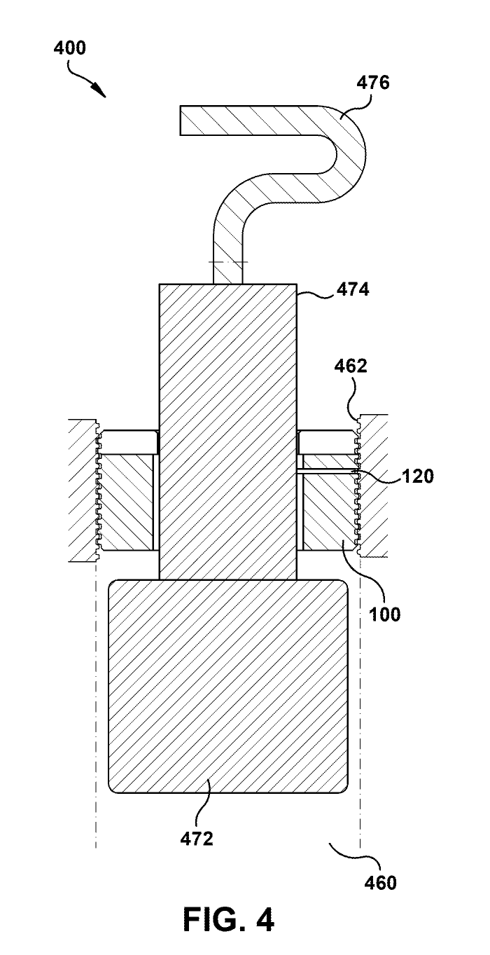

FIG. 4 illustrates a partial, cross-sectional view of a terminal assembly 400 for an electric generator machine. The terminal assembly 400 is inserted within cavity 460 having internally threaded walls 462 over at least a portion thereof. The terminal assembly 400 includes a lower element 472 connected to, or formed integrally with, an upper element 474. A connector 476 is attached to the upper element 474, and the connector is used to attach to the rotor windings in the generator (not shown). The terminal assembly is secured in cavity 460 by the use of locking fastener 100. In use, the terminal assembly is first inserted within cavity 460. This is followed by placing the locking fastener around the terminal assembly 400 and then screwing the locking fastener 100 down along threaded walls 462. When the locking fastener 100 reaches the desired position, and/or makes contact with lower element 472, it can be locked into position by manipulation of locking element 135 (not shown in FIG. 4). The locking fastener 135 is used to change the thread pitch of the outer threads on locking fastener 100 and these threads for a lock with the adjacent threads in the walls 462, thereby locking the fastener 100 and terminal assembly 400 into position.

The locking fastener, according to aspects of the present invention, incorporates a locking member that is used to induce relative axial movement between different fastener sections and this relative axial movement pulls a first portion towards a second portion, or pulls a second portion towards a first portion of the at least one threaded surface, or both. In addition, the relative axial movement can also push a first portion away from a second portion, or push a second portion away from a first portion.

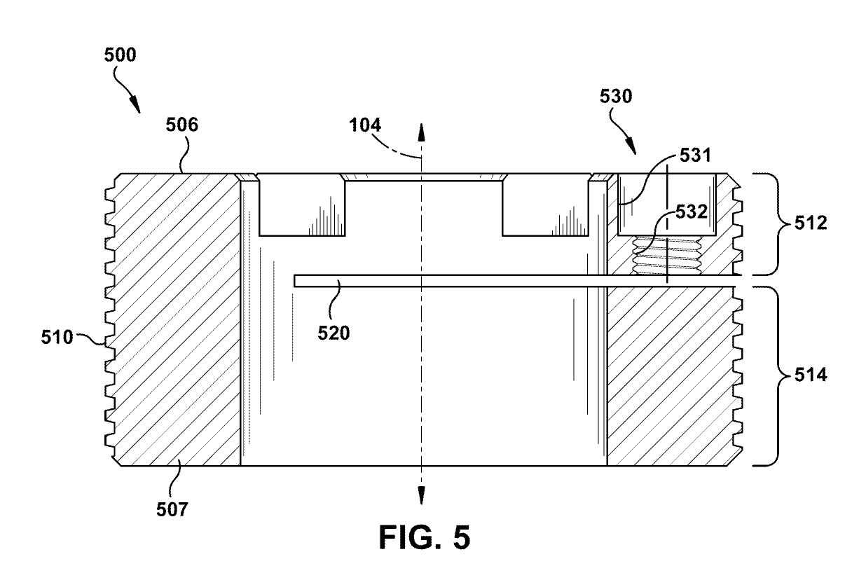

FIG. 5 illustrates a cross-sectional view of locking fastener 500, according to an aspect of the present invention. The locking fastener 500 includes a top surface 506, a bottom surface 507, which is generally opposed to the top surface 506, and a threaded surface 510. The threaded surface 510 includes a plurality of substantially axially directed and radially projecting threads. The threads may be located on the inner and/or outer radial surfaces of locking fastener 500. The threads are generally circumferentially located on these surfaces and form a spiral pattern.

A slot 520 extends from an outer surface to an inner surface of the fastener 500. A first portion 512 of the threaded surface is located above the slot 520 and a second portion 514 of the threaded surface is located below the slot 520. The slot 520 may be configured to extend about 180 degrees or about half way around the locking fastener 500. However, it is to be understood that the slot 520 could be configured to extend greater or less than 180 degrees as well. For example, the slot 520 could be configured to extend about 90 degrees around the fastener 500, or the slot could be configured to extend about 270 degrees fastener 500. In addition, multiple slots (not shown in FIG. 5) could be used and the multiple slots could be disposed to be substantially co-linear with each other, or they may be axially separated so that are substantially parallel with each other.

A locking recess 530 is formed in a portion of the fastener 500 and this locking recess 530 extends substantially parallel to the axis 104 while extending through or to slot 520. The locking recess 530 may have an internal threaded surface portion and/or an internal smooth surface portion. A locking member (not shown), such as a bolt or screw, can be inserted into locking recess 530. In the example shown, the locking recess includes a smooth walled upper portion 531 and a threaded lower section 532. The locking member has an external threaded surface that is configured to engage the threads on the threaded lower section 532.

As the locking member is tightened, the bottom of the locking member makes contact with the lower portion of slot 520 located under recess 530. As the locking member is further tightened, the upper portion 512 and lower portion 514 are pushed away from each other. As shown in FIG. 5, the slot 520 is positioned so that portion 512 will most likely be forced away from lower portion 514. The effect of this relative axial movement changes the thread pitch between the locking fastener 500 and the threaded sidewalls (not shown) into which the locking fastener 500 is inserted. One advantage of the present invention is that the locking fastener 300, 500 requires no prevailing torque when installing, in contrast to prior known fasteners that may use a plastic compound (used as a thread locker) smeared on the threads. Another advantage is that the locking fastener, 300, 500 can be re-used over and over with no requirement to clean the threads as with prior known fasteners.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A locking fastener comprising:
a main body having a first axially directed surface and a second axially directed surface, where both the first axially directed surface and the second axially directed surface surround an axis, the first axially directed surface facing inward toward the axis and the second axially directed surface facing away from the axis;
a top surface extending between the first axially directed surface and the second axially directed surface at a first end of the main body;
a bottom surface extending between the first axially directed surface and the second axially directed surface at a second end of the main body;
at least one threaded surface on the main body, the at least one threaded surface having a plurality of substantially axially directed threads;
at least one slot in the main body, the at least one slot extending from the first axially directed surface to the second axially directed surface, a first portion of the at least one threaded surface located above the at least one slot and a second portion of the at least one threaded surface located below the at least one slot;
a locking recess formed in the main body, the locking recess extending substantially parallel to the axis and extending through or to the at least one slot, the locking recess having an internal threaded surface portion;
a locking member having an external threaded surface, the external threaded surface configured to engage the internal threaded surface portion of the locking recess;
wherein the locking member passes axially through the locking recess and the at least one slot and a tightening of the locking member results in a relative axial movement between the first portion of the at least one threaded surface and the second portion of the at least one threaded surface, and this relative axial movement locks the locking fastener.

2. The locking fastener of claim 1, wherein the at least one threaded surface is on the first axially directed surface.

3. The locking fastener of claim 1, wherein the at least one threaded surface is on the second axially directed surface.

4. The locking fastener of claim 1, wherein the at least one slot circumferentially extends around about half of the main body.

5. The locking fastener of claim 1, wherein the at least one slot includes an enlarged stress relieving area at both ends of the at least one slot.

6. The locking fastener of claim 1, wherein the locking recess includes an internal smooth surface portion.

7. The locking fastener of claim 1, wherein the locking member comprises at least one of a bolt, and a screw.

8. The locking fastener of claim 1, wherein the relative axial movement pulls the first portion of the at least one threaded surface towards the second portion of the at least one threaded surface.

9. The locking fastener of claim 1, wherein the relative axial movement pulls the second portion of the at least one threaded surface towards the first portion of the at least one threaded surface.

10. The locking fastener of claim 1, wherein the relative axial movement pushes the first portion of the at least one threaded surface away from the second portion of the at least one threaded surface.

11. The locking fastener of claim 1, wherein the relative axial movement pushes the second portion of the at least one threaded surface away from the first portion of the at least one threaded surface.

12. A locking fastener comprising:
a main body having a first axially directed surface and a second axially directed surface, where both the first axially directed surface and the second axially directed surface surround an axis;
at least one threaded surface on the main body;
at least one slot in the main body, the at least one slot extending from the first axially directed surface to the second axially directed surface, a first portion of the at least one threaded surface located above the at least one slot and a second portion of the at least one threaded surface located below the at least one slot;
at least one locking recess formed in the main body, the at least one locking recess extending substantially parallel to the axis and extending to or through the at least one slot, the at least one locking recess having an internal threaded surface portion;
at least one locking member having an external threaded surface, the external threaded surface configured to engage the internal threaded surface portion of the at least one locking recess;
wherein the at least one locking member passes axially through the at least one locking recess and the at least one slot and a tightening of the at least one locking member results in a relative axial movement between the first portion of the at least one threaded surface and the second portion of the at least one threaded surface, and this relative axial movement locks the locking fastener.

13. The locking fastener of claim 12, wherein the at least one threaded surface is on an outer surface of the locking fastener.

14. The locking fastener of claim 12, wherein the at least one threaded surface is on an inner surface of the locking fastener.

15. The locking fastener of claim 12, wherein the at least one slot circumferentially extends around about half of the main body.

16. The locking fastener of claim 12, wherein the at least one slot includes an enlarged stress relieving area at both ends of the at least one slot.

17. The locking fastener of claim 12, wherein the at least one locking recess includes an internal smooth surface portion.

18. The locking fastener of claim 12, wherein the at least one locking member comprises at least one of a bolt, and a screw.

19. The locking fastener of claim 12, wherein the relative axial movement either:
pulls the first portion of the at least one threaded surface towards the second portion of the at least one threaded surface; or
pulls the second portion of the at least one threaded surface towards the first portion of the at least one threaded surface.

20. The locking fastener of claim 12, wherein the relative axial movement either:
pushes the first portion of the at least one threaded surface away from the second portion of the at least one threaded surface; or
pushes the second portion of the at least one threaded surface away from the first portion of the at least one threaded surface.
